(19) United States
(12) Patent Application Publication
(10) Pub. No.: US 2018/0288310 A1
(43) Pub. Date: Oct. 4, 2018

(54) DUAL-APERTURE ZOOM DIGITAL CAMERA USER INTERFACE

(71) Applicant: Corephotonics Ltd., Tel-Aviv (IL)

(72) Inventor: Ephraim Goldenberg, Ashdod (IL)

(21) Appl. No.: 15/525,058

(22) PCT Filed: Oct. 10, 2016
(86) PCT No.: PCT/IB2016/056060

§ 371 Date: May 6, 2017

Related U.S. Application Data
(60) Provisional application No. 62/243,292, filed on Oct. 19, 2015.
(60) Provisional application No. 62/253,348, filed on Nov. 10, 2015.

(51) Int. Cl. H04N 5/232; H04N 5/247

(52) U.S. Cl. CPC H04N 5/23216; H04N 5/247; H04N 5/23212; H04N 5/23293; H04N 5/23296; H04N 5/23245

(57) ABSTRACT

A user interface for operating a dual-aperture digital camera included in host device, the dual-aperture digital camera including a Wide camera and a Tele camera, the user interface comprising a screen configured to display at least one icon and an image of a scene acquired with at least one of the Tele and Wide cameras, a frame defining a field of view of a Tele image, the frame superposed on a Wide image having a Wide field of view, and means to switch the screen from displaying the Wide image to displaying the Tele image and vice versa.

### CROSS REFERENCE TO RELATED APPLICATIONS

This application is a 371 application from international patent application No. PCT/IB2016/056060 and claims priority from US Provisional Patent Applications No. 62/243,292 filed on Oct. 19, 2015 and 62/253,348 filed Nov. 10, 2015, both of which applications are expressly incorporated herein by reference in their entirety.

### FIELD

Embodiments disclosed herein relate in general to digital cameras and in particular to thin zoom digital cameras.

### BACKGROUND

Digital camera modules are currently being incorporated into a variety of host devices. Such host devices include cellular telephones, personal data assistants (PDAs), computers, and so forth. Consumer demand for digital camera modules in host devices continues to grow.

Host devices or “personal computing and/or communication devices” (such as smartphones) having two back cameras (also referred to as “dual-camera” or “dual-aperture”) are known. The two back cameras have two sensors operated simultaneously to capture an image and lenses with different focal lengths, so even though each lens/sensor combination is aligned to look in the same direction, each will capture an image of the same subject but with two different fields of view (FOV). One sensor is commonly called “Wide” and the other “Tele”. The cameras are thus called respectively a Wide camera and a Tele camera. Such dual-aperture cameras can perform optical zoom. Each sensor provides a separate image, referred to respectively as “Wide” (or “W”) and “Tele” (or “T”) images. The W-image reflects a wider FOV and has lower resolution than the T-image. The images may be stitched (fused) together to form a composite image. In the composite image, the central portion is formed by the relatively higher-resolution image taken by the lens/sensor combination with the longer focal length, and the peripheral portion is formed by a peripheral portion of the relatively lower-resolution image taken by the lens/sensor combination with the shorter focal length. The user selects a desired amount of zoom and the composite image is used to interpolate values from the chosen amount of zoom to provide a respective zoom image.

In still mode, zoom is achieved by fusing W and T images, with the resulting “fused” image including always information from both images. In video mode, full and smooth optical zoom is achieved by switching between the W and T images. To avoid discontinuities in video mode, the switching may include applying additional processing blocks.

FIG. 1A shows schematically a known dual-camera smartphone numbered 100 in front view. FIG. 1B shows schematically dual-camera smartphone in a back view. As known, smartphone 100 includes, on a back side, two back cameras 102 and 104, which have different fields of view. In some embodiments, one camera (e.g. 102) may be a Wide (large FOV) camera and one camera (e.g. 104) may be a Tele (smaller FOV) camera. The Wide camera FOV (FOV_{W}) and the Tele camera FOV (FOV_{T}) are known, as is a ratio M=FOV_{W}/FOV_{T} between them Smartphone 100 further includes, on a front side opposite to the back side, a screen or display 108 displaying a view of an object or scene (both referred to hereinafter as “scene”) 106. Screen 108 may display icons or text “A”, “B”, “C”, etc., that provide indications and/or are selectable to perform various operations of the phone and/or the cameras. Such icons or text may be indicative of flash setting, video or stills selection, back or front camera selection, etc. The square boxes surrounding “A”, “B” and “C” are merely illustrative and may have different shape or be removed altogether in some cases. Note that the fact that only three icons are shown is not meant to be limiting, and that more or fewer icons may be displayed and/or selectable at any time during image acquisition by the cameras and/or during display of acquired images.

A user of the dual-cameras for still photography or video recording is provided with a “user interface” through screen 108. The user uses the user interface (screen and various icons or text displayed thereon) for various user actions (e.g. by touching the screen). The actions may include selection of various camera smartphone and/or camera functions, the taking of still or video images or frames and responses to various prompts, as known in the art.

In known art, still mode (selectable by an icon or button on the screen) acquisition of a Wide or “fused” (combining inputs from both cameras) image of the scene is performed by both cameras, with the Wide camera providing the entire image filling the screen (i.e. within FOV_{W}) and the Tele camera providing information for the part of the scene within FOV_{T}, centered on screen 108. Image taking is performed by pressing a camera button or icon 110. A “Tele” image may be acquired by increasing the image viewed on the screen (e.g. by two-finger touch) up to a magnification expressing FOV_{T} and pressing camera button or icon 110. However, if the screen shows an FOV greater than FOV_{T}, the user does not know where in the image is the FOV of the Tele camera (where high resolution can be achieved). Therefore, the user cannot take a full Tele image in a simple way. Also, in known art, the user cannot take simultaneously two separate images (of the Wide and Tele cameras) with a single action using button 110.

### SUMMARY

In various embodiments there is provided a user interface for operating a dual-aperture digital camera included in host device, the dual-aperture digital camera including a Wide camera and a Tele camera, the user interface comprising a screen configured to display at least one icon and an image of an object or scene acquired with at least one of the Tele and Wide cameras, a frame defining a field of view FOV_{T} of a Tele image, the frame defining FOV_{T} superposed on a Wide image having a Wide field of view FOV_{W}, and means to switch the screen from displaying the Wide image to displaying the Tele image.

In an exemplary embodiment, the user interface further comprises means to switch the screen from displaying the Tele image to displaying the Wide image.

In an exemplary embodiment, the user interface further comprises means to acquire the Tele image. In an exemplary embodiment, the user interface further comprises means to store and display the acquired Tele image.

In an exemplary embodiment, the user interface further comprises means to acquire simultaneously the Wide image and the Tele image.

In an exemplary embodiment, the user interface further comprises means to store and display separately the Wide and Tele images.

In an exemplary embodiment, the user interface further comprises a focus indicator for the Tele image. In an exemplary embodiment, the user interface further comprises a focus indicator for the Wide image.

In an exemplary embodiment, the user interface further comprises means to switch the screen from displaying the Tele image to displaying the Wide image.

In an exemplary embodiment, the user interface further comprises means for increasing and decreasing the size of the frame, thereby respectively increasing or decreasing a ratio between FOV_{T} and a field of view of the screen FOV_{screen}.

### BRIEF DESCRIPTION OF THE DRAWINGS

Non-limiting examples of embodiments disclosed herein are described below with reference to figures attached hereto that are listed following this paragraph. Identical structures, elements or parts that appear in more than one figure are generally labeled with a same numeral in all the figures in which they appear. The drawings and descriptions are meant to illuminate and clarify embodiments disclosed herein, and should not be considered limiting in any way.

FIG. 1 shows schematically a known dual-camera smartphone in (a) front view and (b) back view;

FIG. 2 shows schematically an embodiment of a screen (front view) and user interface of a dual-camera smartphone disclosed herein;

FIG. 3 shows schematically a first mode of photography with the smartphone of FIG. 2 that simultaneously acquires two, Wide and Tele images;

FIG. 4 shows schematically a second mode of photography with the smartphone of FIG. 2 that acquires only the Wide image;

FIG. 5 shows schematically the choice of transferring the screen from a current state to show the Tele camera image for image acquisition;

FIG. 6 shows the chosen Tele image displayed on the entire smartphone screen;

FIG. 7 shows schematically the action of acquiring the Tele image in a third mode of photography with the smartphone of FIG. 2;

FIG. 8 shows schematically a procedure to return the smartphone from the state of FIG. 6 to a state as in FIG. 2;

FIG. 9 shows a pinching mode used on a user interface to increase a screen field of view;

FIG. 10 shows a possible result of a pinch-out action using a user interface as in FIG. 2;

FIG. 11 shows a pinching action using a user interface as in FIG. 2 that increases or decreases a screen field of view;

FIG. 12 shows a possible result of a pinch-out action using a user interface that results in the entire Tele image or part of the Tele image filling in the screen;

FIG. 13 shows a pinching action applied on the image in FIG. 12.

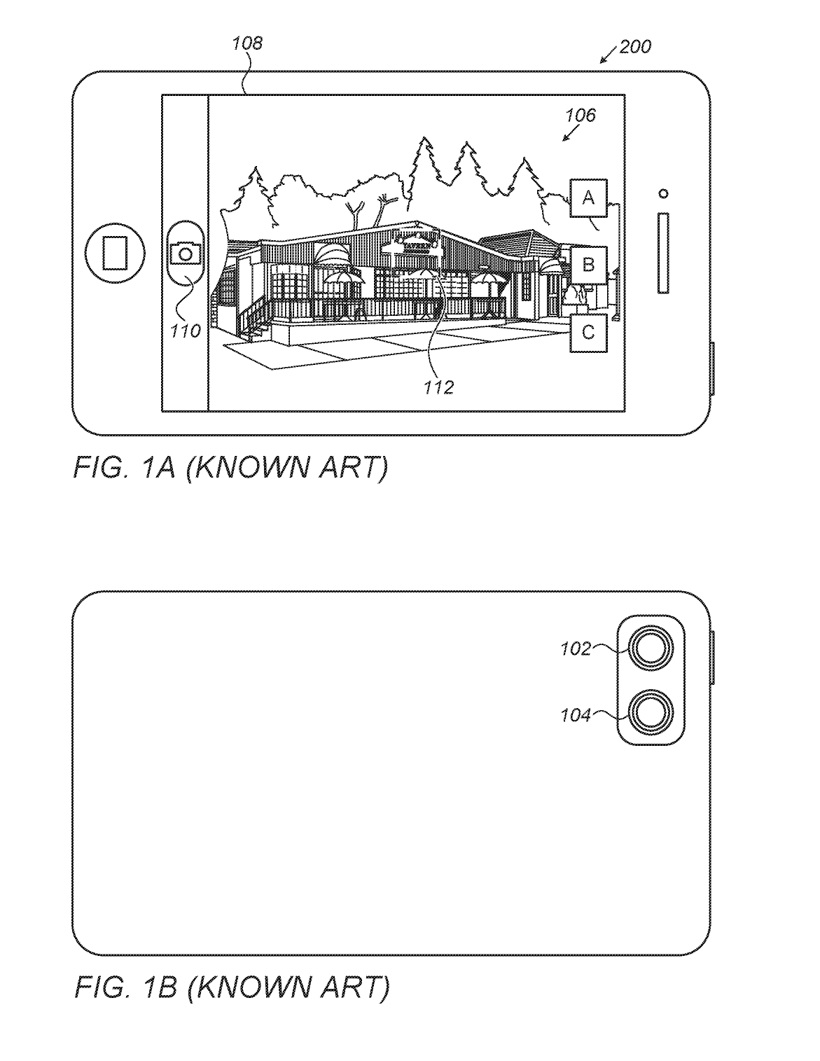

### DETAILED DESCRIPTION

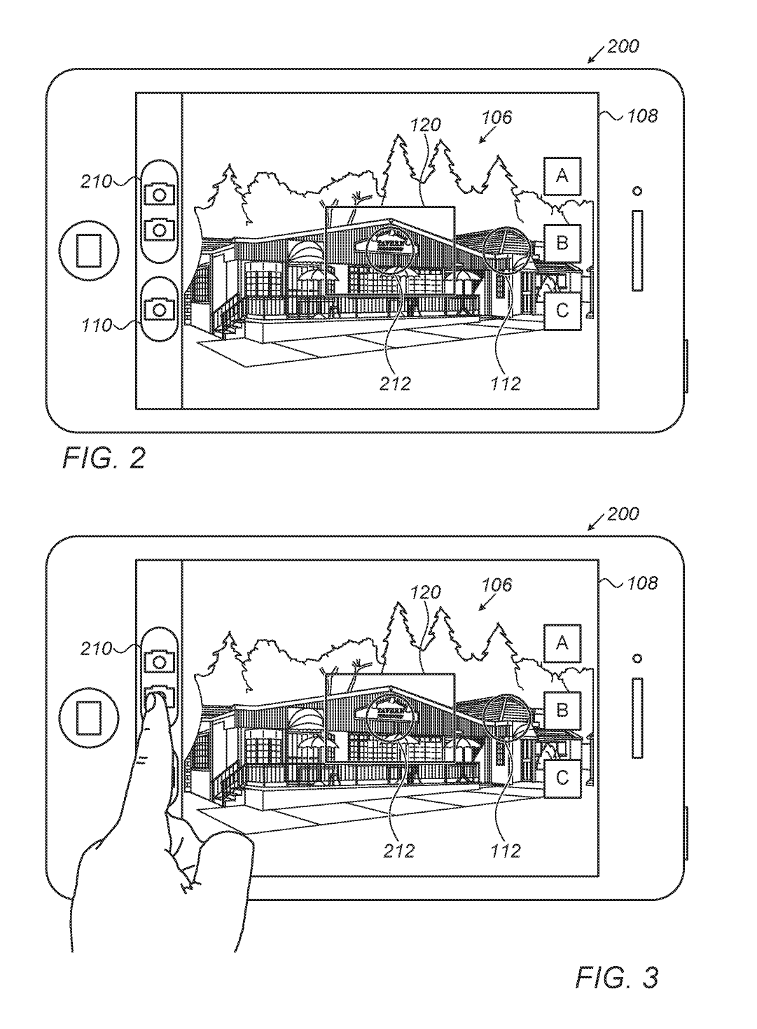

FIG. 2 shows schematically an embodiment of a dual-camera smartphone numbered 200 in front view. “Smartphone” is used hereinbelow to represent any personal computing or communication devices having photography (stills and or video) capabilities. Similar to camera 100, camera 200 includes two back-cameras (not shown) for acquiring and displaying image 106 on screen 108. That is, camera 200 is a “dual aperture” or “dual-camera” camera. As with camera 100, in still mode scene 106 is acquired by both cameras, with the Wide camera providing the entire image seen (referred to as “Wide image”) and the Tele camera providing a part of scene 106, centered on screen 108. However, in camera 200, the part of scene 106 viewed and acquired by the Tele camera (and further referred to as the “Tele image”) is bound by a frame 120. Frame 120 is centered on the screen, includes almost exactly the image seen by the Tele camera FOV (FOV_{T}), and has a size that is a fraction M of the entire screen (which includes the image seen by the Wide camera FOV, “FOV_{W}”). A focus indicator 212 indicates a focused section of the Tele image. In contrast with camera 100, the user interface in camera 200 includes a “two-camera” icon (“button”) 210 which is exemplarily (but need not be) positioned next to the one-camera button 110. Two-camera icon or button 210 may appear on the screen when the FOV of the scene is greater or equal to FOV_{T}. In contrast with known user interfaces in smartphones, a user interface disclosed herein displays visually the almost exact Tele FOV. A user interface disclosed herein enables simple acquisition of the image within the Tele FOV, thereby providing a Tele image with the highest resolution enabled by the Tele camera. A user interface disclosed herein also enables simultaneous acquisition (with a single input through the user interface, i.e. using two-camera button 210) of a Wide image and a Tele image.

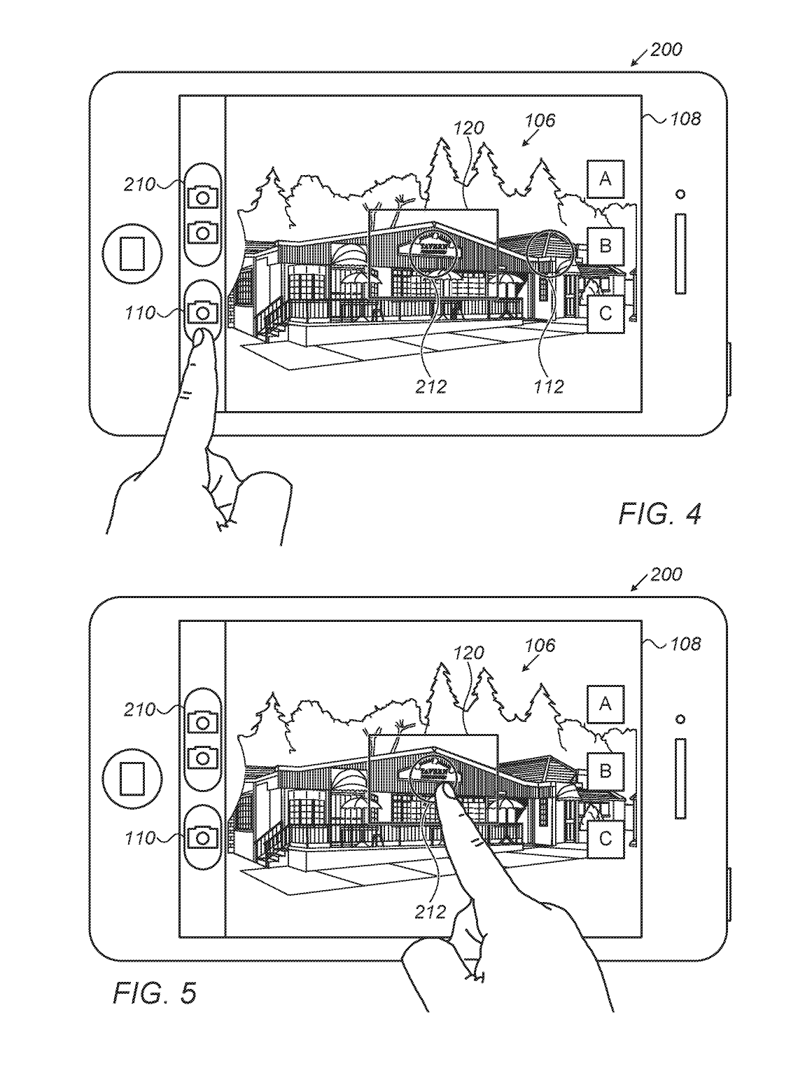

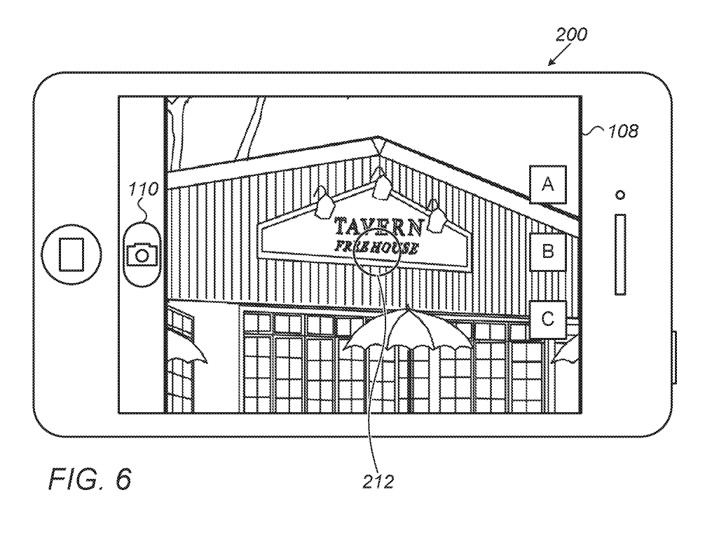

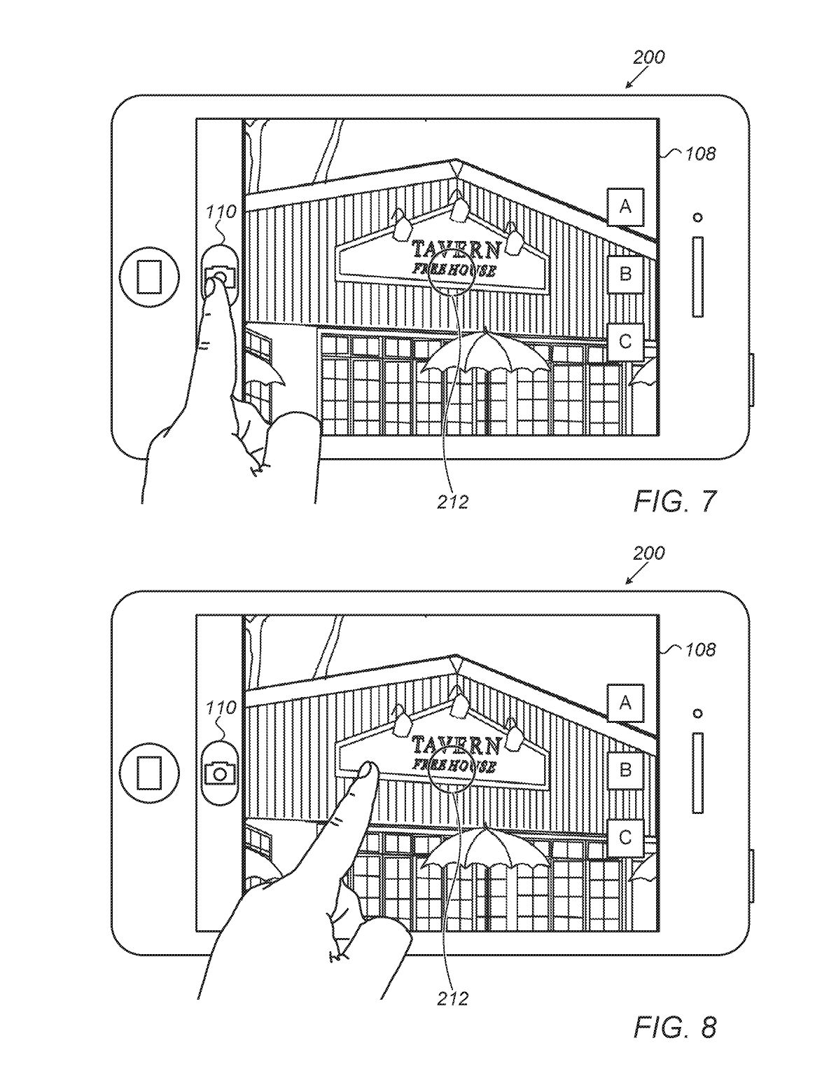

The operation of smartphone 200 for stills photography is now described with reference to FIGS. 3-8. In a first mode of operation shown in FIG. 3, a user may press two-camera button 210 to simultaneously acquire two images, the Wide image of scene 106 at its respective (lower) image resolution and the Tele image of region 120 at its respective (higher) image resolution. The two images may be stored in an on-board storage (such as “camera roll” in an iPhone) and may be displayed or downloaded for further use as known in the art. In a second mode of operation shown in FIG. 4, the user may press single camera button 110 to acquire only the Wide image, which can further be stored, displayed and downloaded for further use. In a third mode of operation shown in FIG. 5, the user may choose for display on screen 108 only the Tele image by, for example, double-tapping or pressing at any point on the screen within frame 120. As shown in FIG. 6, this action leads to display of the Tele image on the entire screen. The Tele image (only) can then be chosen for acquisition by pressing on single camera button 110, FIG. 7. The acquired Tele image can then be stored, displayed and downloaded for further use as above. From the state in FIG. 6 (or 7), the smartphone can be returned to a screen similar to that in FIG. 2 that views a current scene with both cameras by tapping anywhere on the Tele image, see FIG. 8.

Camera 200 may be used for video operation in a similar way, using a “video” button (not shown): if the screen shows the Wide camera image with Tele image frame 120 (as in FIG. 2), the video button will operate Wide camera video recording. If the screen shows the Tele image (as in FIG. 6) then the video button will operate Tele camera video recording. In an alternative embodiment, the screen may exhibit a “double-video” video button (not shown) which, when pressed, will video record the scene using the two cameras simultaneously.

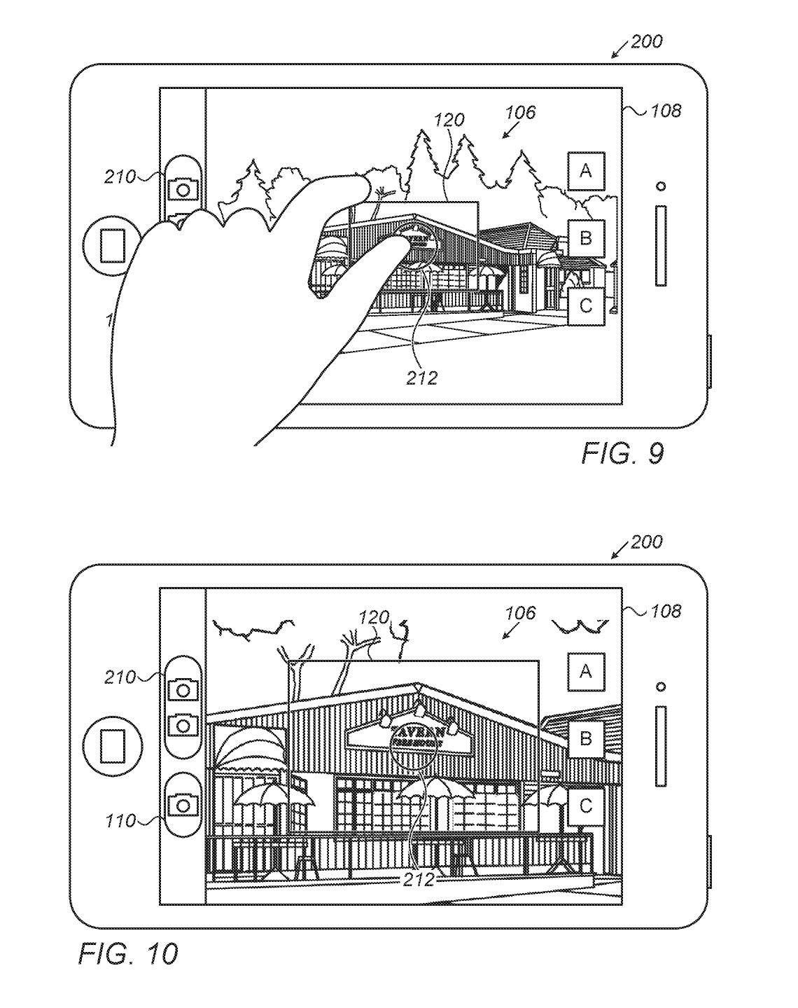

Reference is made now to FIG. 9, which shows a pinching mode used on a user interface to increase a screen field of view. The figure shows a user hand applying a “pinching” action to screen 108. The pinching action may increase or decrease the distance between fingertips touching the screen and provides a “digital zoom”. The use of pinching actions to enlarge or reduce the size of an image displayed on a smartphone screen (equivalent respectively to digital “zoom in” that decreases the screen image FOV (referred to hereinafter as FOV_{screen}) and to digital “zoom out” that increases the FOV_{screen} is well known. Such actions determine the size of the acquired image.

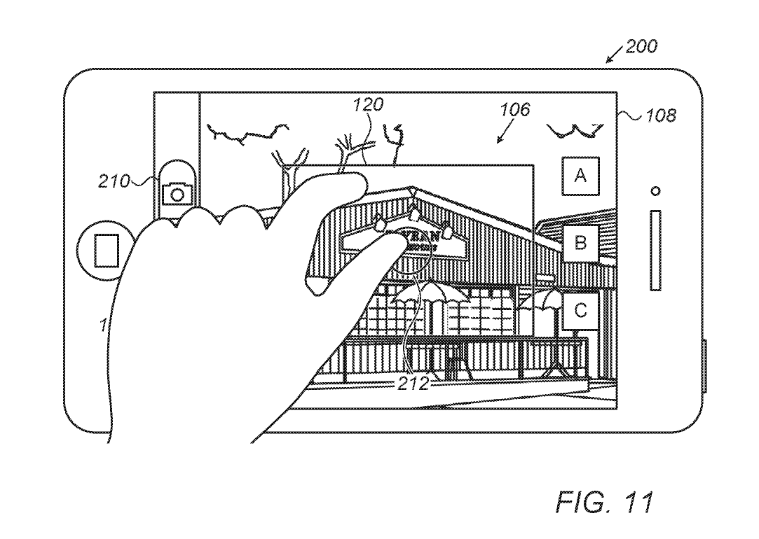

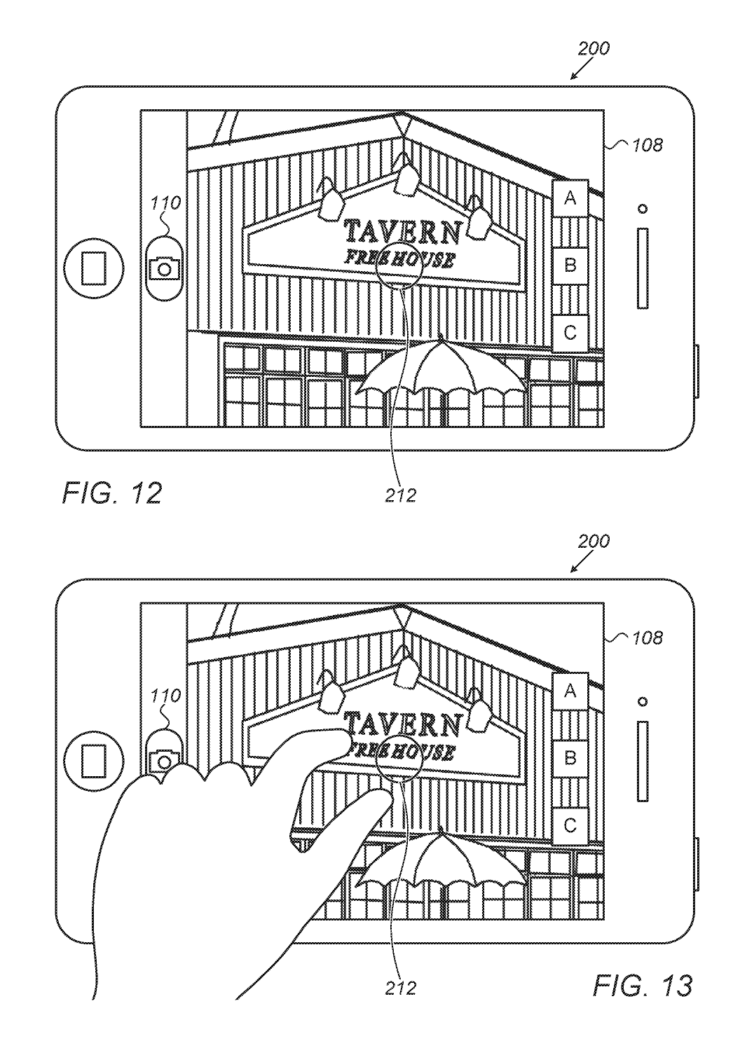

In the embodiment shown in FIG. 9, the pinching action is applied to a screen displaying (as in FIG. 2) both the Wide image and the Tele image bound by frame 120. In a case of “pinch-out”, the FOV_{screen} decreases and the Tele frame size increases, see FIG. 10. In a case of “pinch-in”, FIG. 11, the FOV_{screen} increases and the Tele frame size decreases. In contrast with the digital zoom action in a regular single aperture camera, in dual-aperture camera embodiments disclosed herein this action is not a digital zoom action, since the image of the scene is always acquired with both Wide and Tele cameras. In embodiments disclosed herein, in a “pinch-out” action that decreases the FOV_{screen} (and increases the size of frame 120), more and more of the information acquired is that of the Tele camera. In a limiting case shown in FIG. 12, the Tele image may fill in the entire screen (and frame 120 disappears). In a “pinch-in” action that increases the FOV_{screen} (and decreases the size of frame 120), less and less of the information acquired is that of the Tele camera. Thus, “pinch-in” applied to the image of FIG. 12 (shown in FIG. 13), reduces the FOV_{screen} and can return the screen to displaying both Tele and Wide images, with frame 120 visible on the screen.

To summarize, the pinching actions applied to screen of dual-aperture cameras disclosed herein enable additional modes of image acquisition (whether still or video). Thus, the state shown in FIG. 9 relates to a first state of maximal FOV_{T} and FOV_{screen} Pinch-out on this screen leads to the state in FIG. 10. When FOV_{screen}>FOV_{T} (FIGS. 9-11), frame 120 and two-camera button 210 are displayed and the image on the screen comes from the Wide camera with digital zoom matching the FOV_{screen}. When FOV_{screen} is smaller than or equal to FOV_{T}, FIGS. 12-13, frame 120 and two-camera button 210 are not displayed and the screen image comes only from the Tele camera with digital zoom matching FOV_{T}.

In terms of image acquisition, the pressing of two-camera button 210 in FIG. 10 simultaneously acquires two images, a Wide image of the part of scene 106 seen on the screen (with or without fusion with input from the Tele camera) and the other of the Tele image seen in frame 120. The screen may be changed from the state shown in FIG. 10 (or FIG. 11) to the state shown in FIG. 12 by, exemplarily, two quick taps on the screen. In FIG. 12, which shows only the Tele image at a minimal FOV_{T} frame 120 and two-camera button 210 do not appear on the screen (as they are not needed). The state of only a Tele image filling the screen in FIG. 12 may be returned to the state in FIG. 2 or 9 by (exemplarily) two-quick taps on the screen.

In all states, pressing one-camera button 110 leads to the acquisition of an image having the FOV seen on the screen.

While this disclosure has been described in terms of certain embodiments and generally associated methods, alterations and permutations of the embodiments and methods will be apparent to those skilled in the art. The disclosure is to be understood as not limited by the specific embodiments described herein, but only by the scope of the appended claims.

1. A user interface for operating a dual-aperture digital camera included in host device, the dual-aperture digital camera including a Wide camera and a Tele camera, the user interface comprising:
a) a screen configured to display at least one icon and an image of a scene acquired with at least one of the Tele and Wide cameras;
b) a visual frame defining a field of view FOV_{T} bounding a Tele image, the frame superposed on a Wide image with a Wide field of view FOV_{W}; and
c) means for switching the screen from displaying the Wide image to displaying the Tele image.

2. The user interface of claim 1, further comprising means to acquire the Tele image.

3. The user interface of claim 2, further comprising means to acquire simultaneously the Wide image and the Tele image.

4. The user interface of claim 2, further comprising means to store and display the acquired Tele image.

5. The user interface of claim 3, further comprising means to store and display separately the Wide and Tele images.

6. The user interface of claim 1, further comprising a focus indicator for the Tele image.

7. The user interface of claim 6, further comprising a focus indicator for the Wide image.

8. The user interface of claim 1, further comprising means to switch the screen from displaying the Tele image to displaying the Wide image.

9. The user interface of claim 1, further comprising means for increasing and decreasing the size of the frame, thereby respectively increasing or decreasing a ratio between FOV_{T} and a field of view of the screen FOV_{screen}.
